(19) United States
(12) Patent Application Publication
(10) Pub. No.: US 2017/0113075 A1
(43) Pub. Date: Apr. 27, 2017

(54) Supply Device for Supplying Breathable Air

(71) Applicant: Avea Capital Ltd., Road Town - Tortola (VG)

(72) Inventors: Stefan Reiser, Hochdorf (DE); Ian Briggs, Stuttgart (DE); Thor Unbescheid, München (DE); Peter Jud, Metzingen (DE); Alexander Lorenz, Esslingen (DE); Mark Ital, Stuttgart (DE)

(21) Appl. No.: 15/126,618

(22) PCT Filed: Mar. 18, 2015
(86) PCT No.: PCT/EP2015/000595

§ 371 Date: Sep. 16, 2016

(30) Foreign Application Priority Data
Mar. 18, 2014 (DE) 10 2014 003 866.1

(51) Int. Cl. A62B 18/00; A62B 9/04; A62B 23/02

(52) U.S. Cl. CPC A62B 18/003; A62B 18/006; A62B 23/02; A62B 9/04

(57) ABSTRACT

The invention relates to a supply device (1, 51, 81, 101) for supplying breathable air to a breathable air region (2, 52, 82) which is at least partially open to the surroundings. Said supply device comprises means for generating a flow of air (3, 53, 83) for supplying breathable air to the breathable air region (2, 52, 82). Said supply device (1, 51, 81, 101) also comprises means for generating at least one shielding air flow (4, 5, 54, 84) which shields the breathable air flow (2, 52, 82) at least partially with respect to the surroundings.

The invention concerns a supply device for supply of breathing air of the kind identified in the preamble of claim 1.

JP 2008-212603 A discloses a sun visor that generates a fresh air stream across the skin of an operator. For shielding against the surroundings, a visor is provided behind which the air is blown in.

In order to protect human beings from air pollution, infections, pollen or the like, breathing masks are also known that can be worn in front of mouth and nose. These breathing masks are often perceived by the user as bothersome and change the appearance of the user.

The invention has the object to provide a supply device for supply of breathing air of the aforementioned kind that is not perceived by the user as bothersome and that provides a satisfactory protection from air pollution and the like.

This object is solved by a supply device for supply of breathing air with the features of claim 1.

It is provided that the shielding of the breathing air region relative to the surroundings is realized by at least one shielding air stream. In this way, a shielding element, such as a visor, a breathing mask, or the like is obsolete. The movement of the user is not impaired. Due to the shielding air stream, the appearance of the user is also not changed. The mouth of the user remains visible so that communication is also not impaired.

Advantageously, the flow rate of the shielding air stream is greater than the flow rate of the supply air stream. By a comparatively high flow rate of the shielding air stream, a reliable shielding of the breathing air region can be achieved relative to the surroundings, even when the user is moving or when wind is blowing, and it can be ensured that the user is breathing in only the supplied breathing air and no ambient air. In this context, the flow rate of the shielding air stream is advantageously at least twice as great as the flow rate of the supply air stream. By means of a reduced flow rate of the supply air stream, the user is not impaired by the supply air stream. There is no uncomfortable sensation of an air draft. Also, excessive drying of the mucous membranes and the eyes can be avoided by a minimal flow rate of the supply air stream. Advantageously, the flow rate of the shielding air stream amounts to approximately 0.3 m/s to approximately 1.5 m/s. A flow rate of the shielding air stream of approximately 0.5 m/s to approximately 1 m/s has been proven to be particularly advantageous. The flow rate of the supply air stream advantageously is approximately up to 0.25 m/s. In this way, the supply air stream is felt only minimally by the operator and is not perceived as being uncomfortable.

A simple configuration of the supply device results when the means for generating the shielding air stream comprise at least one first outflow opening and the means for generating a supply air stream comprise at least one second outflow opening. The width of the first outflow opening is advantageously smaller than the width of the second outflow opening. As a result of the different widths of the first and second outflow openings, the flow rate of the shielding air stream and of the supply air stream as a function of the supply air stream can be adjusted in a simple way. In this way, the first and the second outflow openings can be supplied by the same air source. The different flow rates and flow directions can be defined solely by the position and size of the outflow openings.

A simple configuration results when the supply device comprises a blower that sucks in the ambient air and conveys it to at least one outflow opening. In this way, a compact configuration of the supply device is provided and the supplied breathing air must not be stored. Alternatively, it can however also be provided that a pressure container with air under pressure can be provided for supply of the breathing air. This is in particular expedient when there are special requirements in regard to the composition and/air purity of the breathing air to be supplied.

When intake of ambient air is employed for supply of breathing air, the ambient air is advantageously sucked in through at least one filter. In this way, contaminants of the ambient air can be filtered out so that the operator is supplied with purified ambient air as breathing air. In particular, several filters of different filter classes can be provided which filter with different fineness. Accordingly, particles as well as pollen, bacteria, germs, viruses, smoke, carbon-particulate matter, and the like can be separated from the ambient air.

A simple configuration results when the supply device comprises a supply part on which the outflow openings are arranged. The supply part has in particular at least one connector for an air supply. The supply part can be connected in this way by a supply hose or the like with the blower of the pressure container. Accordingly, the blower can be carried by the operator, for example, in a backpack on the back so that an ergonomic arrangement of the blower results. When the supply device is used, for example, on a baby carriage or buggy, the blower can be transported in a storage basket underneath the baby carriage or buggy.

In order to be able to adjust the air quantity to be supplied to the individual outflow openings, it is advantageously provided that the supply part comprises at least one first sub-channel and at least one second sub-channel. The at least one first outflow opening is advantageously connected with the at least one first sub-channel and the at least one second outflow opening is connected with the at least one second sub-channel. By suitable adjustment of the dimensions of the sub-channels, i.e., by adjustment of the lengths and the flow cross-sections, the air quantity supplied in operation to the individual outflow openings can be determined. In order to enable adaptation to different conditions or different users, it is advantageously provided that the position of at least one outflow opening can be adjusted on the supply part itself.

Advantageously, the supply part comprises a support section for support on a user. The outlet opening opens advantageously toward the side which is facing away from the support section. The support section can be configured, for example, for support in the area of the clavicle or in the chest area of a user. The supply device can also be provided for arrangement on a baby carriage, buggy, or the like. For this purpose, it is advantageously provided that the supply device comprises at least one fastening element. With the fastening element, the supply device can be secured, for example, on a canopy or a strut of the baby carriage or buggy.

It can be advantageous to provide several shielding air streams on opposed sides of the supply air stream so that the breathing air region is shielded well from the surroundings and is guided into the region where a user breathes the breathing air. For example, in case of arrangement on a baby carriage or buggy, it can also be provided that shielding air streams are generated on all sides about the supply air stream.

Embodiments of the invention will be explained in the following with the aid of the drawing. It is shown in:

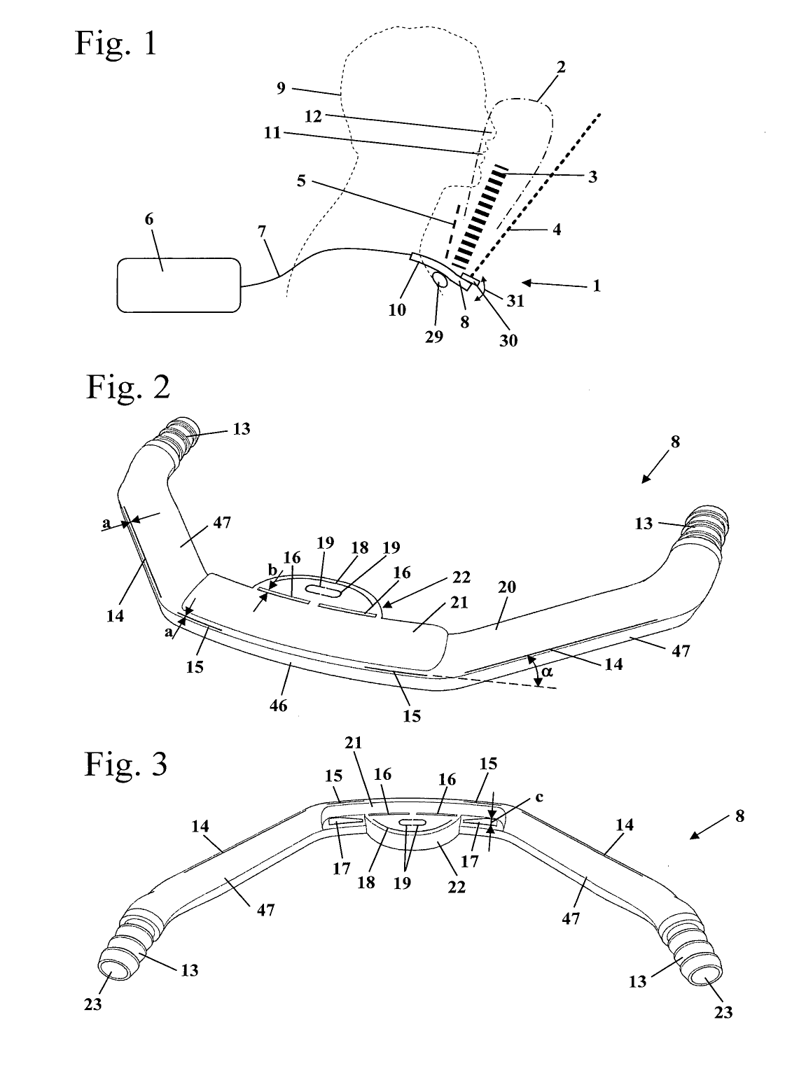

FIG. 1 a schematic illustration of a first supply device for supply of breathing air to a user;

FIGS. 2 and 3 perspective illustrations of the supply part of the supply device of FIG. 1;

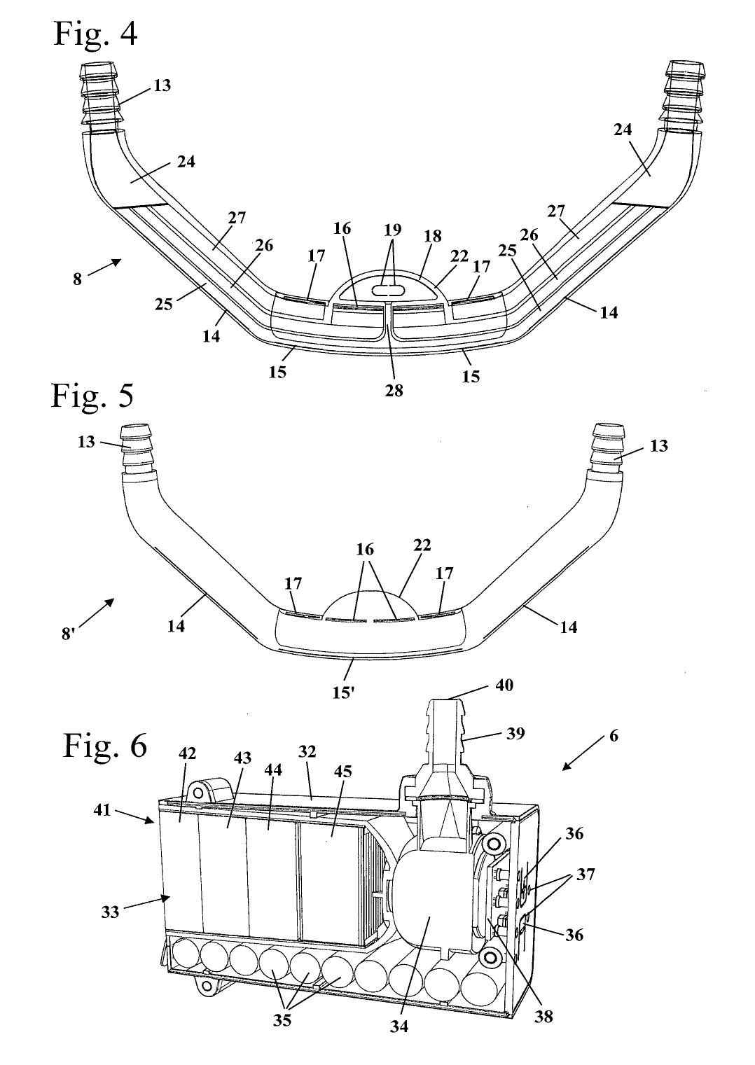

FIG. 4 a plan view of the supply part in transparent illustration;

FIG. 5 a plan view of an embodiment of the supply part;

FIG. 6 a perspective section illustration of the blower unit;

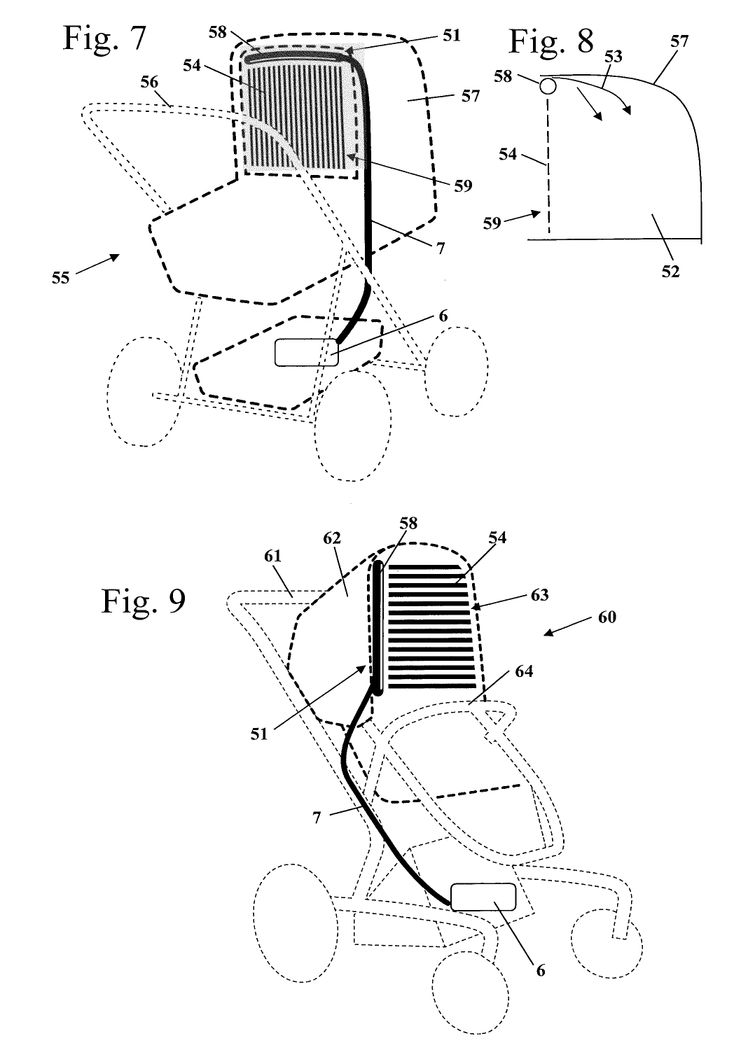

FIG. 7 a schematic illustration of an embodiment of a supply device on a baby carriage;

FIG. 8 a schematic section illustration through the supply part and the baby carriage of FIG. 7;

FIG. 9 a schematic illustration of a supply device on a buggy;

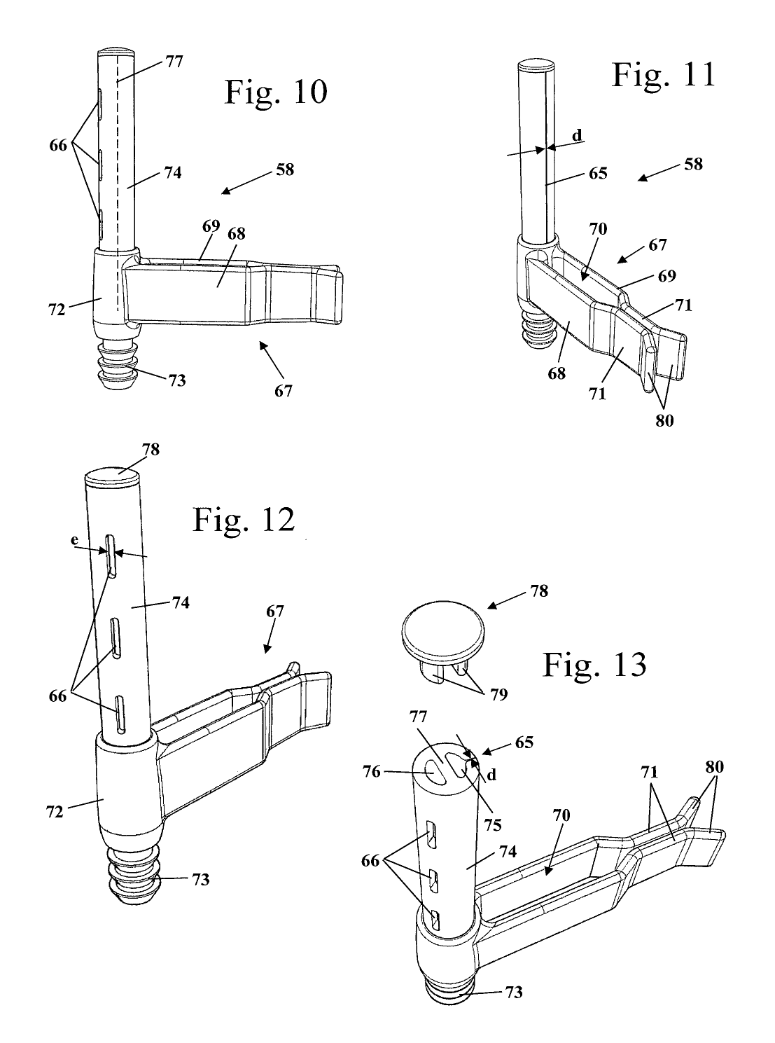

FIGS. 10 to 12 perspective illustrations of the supply part of the supply device of FIGS. 7 to 9;

FIG. 13 a perspective exploded illustration of the supply part of FIGS. 10 to 12;

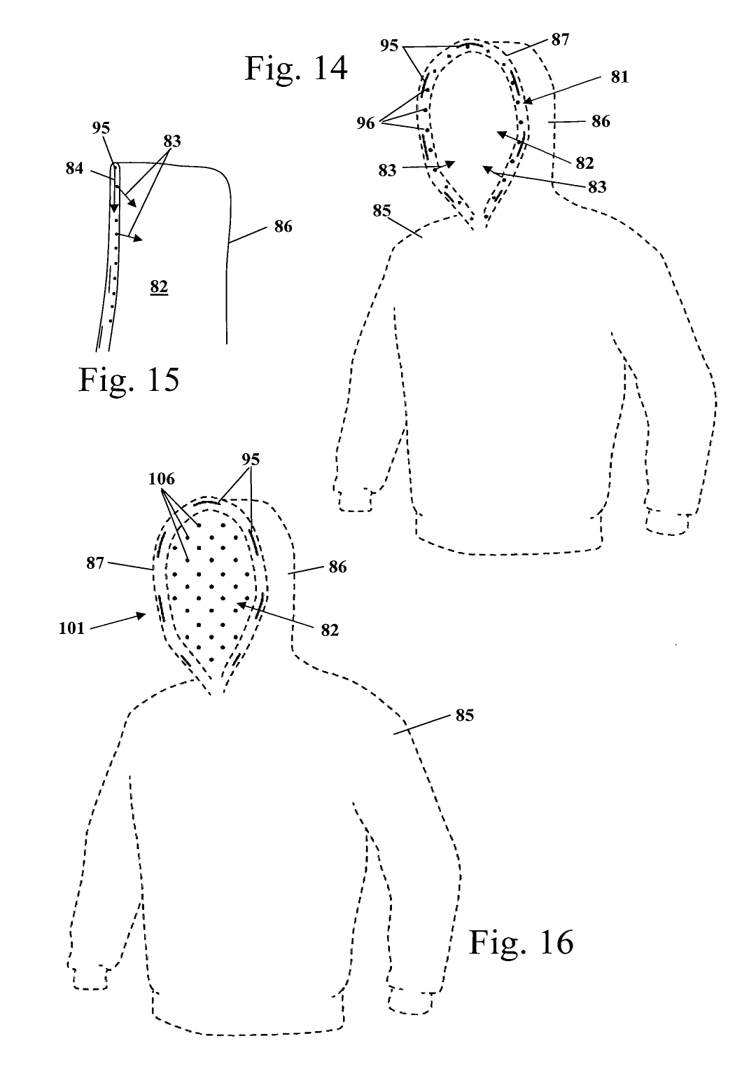

FIG. 14 a schematic illustration of a supply device on a hooded sweater;

FIG. 15 a schematic section illustration of the hood of the hooded sweater of FIG. 14;

FIG. 16 a schematic illustration of a further embodiment of a supply device on a hooded sweater.

FIG. 1 shows schematically a supply device 1 carried by a user 9. The supply device 1 comprises a supply part 8 that, similar to a necklace, is supported in the clavicle area of the user 9. In the embodiment, the supply part 8 comprises at least one support section 10 which is resting on the clavicle area of the user 9. Preferably, two support sections 10 adjacent to the shoulders of the user 9 are provided. Additionally or alternatively, the supply part 8 can be resting in the area of an adjusting device 29 on the user 9. The adjusting device 29 will be explained in more detail in the following.

The supply part 8 is connected by at least one supply hose 7 with a blower unit 6. Advantageously, two supply hoses 7 are extending symmetrically on both sides of the neck of the user 9 so that the supply part 8 is secured by means of the supply hose 7 on the user 9. One supply air hose 7 may also be advantageous. The user 9 has a mouth 11 and a nose 12 that extend into a breathing air region 2. The supply device 1 supplies breathing air in the form of a supply air stream 3 into the breathing air region 2. The supply air stream 3 comprises a very minimal flow rate. The flow rate of the supply air stream 3 is advantageously up to 0.25 m/s, in particular up to approximately 0.2 m/s. The flow rate of the supply air stream 3 is advantageously so minimal that the user 9 experiences no uncomfortable sensation of an air stream, in particular at mouth 11 and nose 12 and at the eyes, not illustrated in FIG. 1.

In order to ensure that the supply air stream 3 reaches the area of mouth 11 and nose 12 even when the user 9 is moving or when the user 9 is standing in an air flow, for example, as a result of wind or an air conditioning device, the supply device 1 generates shielding air streams 4 and 5. The shielding air streams 4 and 5 separate the breathing air region 2 from the surroundings. In this way, the user 9 breathes breathing air supplied by the supply device and not ambient air. A first shielding air stream 4 flows on the side of the breathing air region 2 which is facing away from the user 9. The flow rate of the first shielding air stream 4 is advantageously so great that the flow direction of the shielding air stream 4 is substantially maintained even in case of movement of the user 9 and so that no ambient air can be breathed in by the user 9. The flow rate of the shielding air stream is advantageously approximately 0.3 m/s to approximately 1.5 m/s, preferably approximately 0.5 m/s to approximately 1 m/s. A second shielding air stream 5 flows on the side of the breathing air region 2 and of the supply air stream 3 facing away from the first shielding air stream 4. The second shielding air stream 5 is oriented approximately in the direction of the chin/neck region of the user 9. The second shielding air stream 5 prevents deflection of the supply air stream 3 and guides the supply air stream 3 in the direction toward mouth 11 and nose 12.

In order to be able to adjust the orientation of the supply air stream 3 and of the shielding air streams 4 and 5 to different users 9, the adjusting device 29 is provided. The adjusting device 29 can be designed, for example, as a gel cushion, air cushion, or the like. By means of the adjusting device 29, the slant of the supply part 8 relative to the clavicle area of the user 9 can be adjusted.

Alternatively or additionally, an adjusting device 30 can be provided with which the orientation of one or several of the air streams generated by the supply part 8 can be adjusted. In the embodiment, the adjusting device 30 is supported so as to be pivotable in the direction of double arrow 31 on the supply part 8. On the adjusting device 30, outflow openings for generating the first shielding air stream 4 are arranged. In this way, the orientation of the first shielding air stream 4 can be changed by pivoting the adjusting device 30. For this purpose, an adjusting wheel or the like can be provided, for example.

FIGS. 2 and 3 show the configuration of the supply part 8 in detail. The supply part 8 comprises an elongate tubular shape. On both ends of the supply part 8 a connector 13 is provided, respectively, for connecting a supply hose 7. In the embodiment, the connectors 13 are designed as connecting sockets onto which the supply hose 7 is pushed. The supply part 8 comprises outflow openings 14 and 15 that are symmetrically arranged and serve for generating the first shielding air stream 4. As shown in FIG. 2, the outflow openings 14 and 15 have a width a which is very minimal. Advantageously, the width a is less than approximately 1 mm. The outflow openings 14 and 15 are designed as narrow slots whose length is multiple times greater than the width. The outflow openings 15 are oriented approximately in transverse direction of the user 9. The outflow openings 14 are slanted relative thereto and, when the supply part 8 is arranged on the user, extend from the area which is facing the outflow openings 15 at a slant to the rear and to the top, relative to the user 9, as well as away from each other. The first shielding air stream 4 extends therefore not only in front of the face of the user 9 but also laterally therefrom at a spacing to the face of the user 9. In this way, a lateral penetration of ambient air into the breathing air region 2 is prevented also. In a plane that contains the outflow openings 14, 15, the outflow openings 14 and 15 are positioned relative to each other advantageously at an angle α which is from approximately 20° to approximately 60°.

The outflow openings 15 are arranged on a central section 46 of the supply part 8. Lateral sections 47 adjoin at both sides the central section 46 and an outflow opening 14 is arranged on each one of them. The outflow openings 14 and 15 are arranged on the side which is facing away from the support section 10 (FIG. 1) and open toward the side which is facing away from the support section 10. On the side which is facing the breathing air region 2, the supply part 8 comprises at the central section 46 a raised portion 21 that is embodied as a thicker portion of the approximately tubular base member 20 of the supply part 8. A projection 22 adjoins the raised portion 21 at the side which is facing the neck of a user 9 and is embodied to have a disk shape. On the top side of the projection 22 an outflow opening 18 is arranged whose width corresponds approximately to the width a of the outflow openings 14 and 15. The outflow opening 18 extends in an arc shape and parallel to the outer contour of the projection 22 and is designed as a narrow slot. In the area which is surrounded by the first outflow opening 18 two outflow openings 19 are arranged which are each approximately U-shaped wherein the ends of the two outflow openings 19 are arranged to be closely neighboring each other. The outflow openings 18 and 19 generate the second shielding air stream 5.

As shown in FIGS. 2 and 3, at the transition from the raised portion 21 into the projection 22 two outflow openings 16 are arranged which serve for generating the supply air stream 3. The outflow openings 16 are oriented approximately parallel to the outflow openings 15 and in transverse direction of the user 9. The outflow openings 16 are slot-shaped wherein the length of the outflow openings 16, measured in transverse direction of the user 9, is significantly smaller than the width b of the outflow openings 16. The width b of the outflow openings 16 is significantly greater than the width a of the outflow openings 14 and 15. In this way, the breathing air which is exiting from the outflow openings 16 has a significantly smaller flow rate compared to the air exiting from the outflow openings 14 and 15.

As shown in FIG. 3, on the end face of the raised portion 22 facing the user 9, an outflow opening 17 is arranged on either side of the projection 22, respectively. The outflow openings 17 comprise an approximately wedge-shaped flow cross-section which has its greatest width c in the areas facing away from the projection 22 and facing the lateral sections 47. The width c is significantly greater than the width a of the outflow openings 14 and 15. In the embodiment, the width c is also significantly greater than the width b of the outflow openings 16. Due to the horizontal orientation of the outflow openings 17 an advantageous supply of the breathing air stream 3 into the breathing air region 2 is provided. The outflow openings 14, 15, 18, and 19 are designed such that the flow rate of the shielding air stream 4, 5 exiting through the outflow openings 14, 15, 18, 19 is approximately 0.3 m/s to approximately 1.5 m/s, advantageously approximately 0.5 m/s to approximately 1 m/s. The dimensions of the outflow openings 16 and 17 are selected such that the supply air stream 3 which is exiting through the outflow openings 16 and 17 has a flow rate of not more than approximately 0.25 m/s, in particular of not more than approximately 0.2 m/s.

As is shown in the transparent illustration of FIG. 4, a supply channel 24 is formed in the supply part 8 adjoining the connector 13. As shown in FIG. 3, on each connector 13 an air inlet opening 23 is formed which is communicating with the supply channel 24 shown in FIG. 4. In the lateral sections 47, the supply channel 24 is divided into three sub-channels 25, 26, 27. The sub-channels 25 serve for generating the shielding air streams 4 and 5. The sub-channels 25 from the two connectors 13 meet at the geometric center of the supply part 8 and are guided through a common channel section 28 into the projection 22. The outflow openings 14 and 15 are open toward the sub-channel 25 so that air from the sub-channel 25 can flow into the outflow openings 14 and 15 and through the projection 22 into the outflow openings 18 and 19.

The two symmetrically arranged sub-channels 26 each open at an outflow opening 16. The two sub-channels 27 each open at an outflow opening 17. By suitable selection of the lengths and flow cross-sections of the sub-channels 25, 26, and 27, the air quantity used for the shielding air streams 4 and 5 can be adjusted to the air quantity used for the generation of the supply air stream 3.

FIG. 5 shows an embodiment of a supply part 8′ whose configuration is substantially corresponding to the configuration of the supply part 8. The supply part 8′ comprises however no outflow openings at the projection 22. With the supply part 8 a supply air stream 3 and a shielding air stream 4 but no shielding air stream 5 can be generated.

FIG. 6 shows the blower unit 6 in cross-section. The blower unit 6 comprises an air intake opening 41 through which the ambient air can be sucked into a filter unit 33. The blower unit 6 comprises a housing 32 that is substantially open toward one side for forming the air intake opening 41. In the embodiment, the filter unit 33 is designed as a multi-stage filter. The filter unit 33 comprises four filters 42, 43, 44, 45 whose filter class advantageously differs. Advantageously, the filter 42 which is arranged at the air intake opening 41 is the coarsest filter. The finest filter 45 can be, for example, a HEPA filter.

In the housing 32 a blower 34 is arranged that sucks in the ambient air through the filter unit 33 and conveys the filtered breathing air to an air outflow opening 40. In the embodiment, the blower 32 is a radial blower. In this way, a compact configuration results. The air outflow opening 40 is advantageously formed on a connector socket 39 to which the supply hose 7 can be connected. The blower unit 6 comprises operating elements 36 and display elements 37 for operation. The operating elements 36 can be, for example, keys with which the supplied air stream can be increased or reduced. The display elements 37 can be, for example, LEDs. A different kind of display can be advantageous also. A control circuit board 38 is arranged in the housing 32 for controlling. In order to supply the control, the display elements 37, and the blower 34 with energy, batteries 35, preferably rechargeable batteries, can be provided. An electric cable can be provided also for energy supply, for example, for using the supply device 1 in a home. Other types of energy supply can be expedient also.

FIGS. 7 and 8 show schematically an embodiment of a supply device 51 that, for example, can be secured on a baby carriage 55. The baby carriage 55 has a canopy 57 on which a supply part 58 of the supply device 51 is secured. It can also be advantageous to secure the supply device 58, for example, on a handlebar 56 of the baby carriage 55. The canopy 57 has an opening 59 relative to the surroundings. The supply part 58 is arranged adjacent to the opening 59 on the canopy 57. The supply device 51 generates a shielding air stream 54 which prevents that ambient air can reach the interior of the canopy 57 through the opening 59. As shown schematically in FIG. 8, the supply part 58 feeds a supply air stream 53, which advantageously provides purified ambient air, into the breathing air region 52 formed under the canopy 57. Accordingly, a child whose head is arranged within the breathing air region 52 breathes air from the supply air stream 53 and no unpurified ambient air. As also shown in FIG. 7, the blower unit 6 of the supply device 51 can be arranged in a basket of the baby carriage 55 and can be connected by a supply hose 7 with the supply part 58.

FIG. 9 shows an embodiment of the supply device 51 which is secured on a buggy 60. The buggy 60 has a canopy 62. The canopy 62 is open relative to the surroundings at an opening 63. A handlebar 61 of the buggy 60 is arranged behind the canopy 62. The supply part 58 of the supply device 51 is arranged adjacent to the opening 63 and is secured laterally on the canopy 62. The supply part 58 generates a shielding air stream 54 that shields a breathing air region, formed underneath the canopy 62 and not illustrated, relative to the surroundings. As also shown in FIG. 9, the buggy 60 has a transverse frame part 64. It can also be provided that the supply part 58 is arranged on the transverse frame part 64 in particular when the canopy 62 is to be opened.

FIGS. 10 to 13 show the configuration of the supply part 58 in detail. The supply part 58 is approximately rod-shaped and has a fastening clip 67 for fixation on the canopy 57 of the baby carriage 55 or on the canopy 62 of the buggy 60. The supply part 58 comprises a cylindrical base member 74. The base member 74 comprises outflow openings 66 which are arranged in a row aligned in the longitudinal direction of the base member 74 on the outer circumference of the base member 74. The breathing air which is exiting in operation through the outflow openings 66 forms the supply air stream 53.

The supply part 58 comprises a connector 73 for connecting the supply hose 7. On the opposite side, the base member 74 is of a closed configuration. For this purpose, a cover 78 illustrated in FIG. 13 is provided. Alternatively, the supply part 58 can also comprise a connector for a supply hose 7 at both ends, receptively. The interior of the base member 74 is divided by a separating wall 77, schematically indicated in FIG. 10, into two sub-channels. As shown in FIG. 13, the separating wall 77 separates a first sub-channel 75 from a second sub-channel 76. The first sub-channel 75 comprises an outflow opening 65 which has a very minimal width d. The width d is advantageously less than approximately 1 mm. The outflow opening 65 serves for generating the shielding air stream 54. The second sub-channel 76 opens at the outflow openings 66. The cover 78 comprises two securing sockets 79 which are each projecting into one of the sub-channels 75 and 76 and thereby secure the cover 78 on the base member 74.

As shown in FIG. 12, the outflow openings 66 have a width e which is significantly greater than the width d. The width d and the width e are advantageously matched relative to each other such that the flow rate of the supply air stream 53 which is formed by the second outflow opening 66 is significantly smaller than the flow rate of the shielding air stream 54 which is exiting from the first outflow opening 65. Advantageously, the flow speed of the shielding air stream 54 is approximately 0.3 m/s to approximately 1.5 m/s, in particular approximately 0.5 m/s to approximately 1 m/s. The flow rate of the supply air stream 53 is advantageously up to approximately 0.25 m/s, in particular up to 0.2 m/s.

FIGS. 10 to 13 show also the fastening clip 67 in detail. The fastening clip 67 is formed by two brackets 68 and 69 which are mirror-symmetrically arranged and embodied relative to each other. The brackets 68 and 69 are integrally formed on a holding ring 72. The holding ring 72 can be secured fixedly on the base member 74 of the supply part 58 or can be formed monolithically therewith. Advantageously, the holding ring 72 is however rotatable relative to the base member 74 so that the orientation of the outflow openings 65 and 66 can be adjusted to the fastening situation. Between the two brackets 68 and 69 an intermediate space 70 for receiving a section of the canopy 57 or 62 is formed. In the area that is adjoining the intermediate space 70, the two brackets 68 and 69 comprise a clamping section 71, respectively. With their clamping sections 71, the brackets 68 and 69 are contacting each other and are advantageously pretensioned toward each other. In this way, a safe fixation, for example, on the canopy 57 or 62 is made possible. At their free ends 80, the two brackets 68 and 69 are bent away from each other so that the attachment of the fastening clip 67 is facilitated. Instead of the fastening clip 67, other fastening means for fixation of the supply part 58, in particular for fixation on a baby carriage 55 or a buggy 60, can be provided also.

As shown in FIGS. 10 to 13, in the embodiment the outflow openings 65 and 66 are arranged on opposite sides of the base member 74 so that the supply air stream 53 and the shielding air stream 54 are flowing out at opposed sides. However, a different arrangement of the outflow openings 65 and 66 can be provided also. For example, the outflow openings 65 and 66 can be arranged relative to each other such that the supply air stream 53 and the shielding air stream 54 are positioned at an angle of 90° or less relative to each other. The arrangement of the outflow openings 65 and 66 can be adjusted to the intended application situation.

FIG. 14 shows schematically an embodiment of a supply device 81 which is arranged on a hood 86 of a hooded sweater 85. The hood 86 delimits a breathing air region 82 in the interior of the hood 86. First outflow openings 95 and second outflow openings 96 are provided at the forward rim 87 of the hood 86. The outflow openings 95 and 96 can be, for example, arranged on the drawstring loop of the hood 86. The supply device 81 can be embodied, for example, on a hose or the like which is accommodated in the drawing loop. As is shown also in FIG. 15, air that is exiting from the first outflow openings 95 produces a shielding air stream 84. The shielding air stream 84 flows advantageously approximately in a plane of the rim 87. The shielding air stream 84 can also be slanted slightly forwardly, i.e., away from the hood 86, so that a user must not pull the hood 86 deep into his face in order to be within the breathing air region 82 with nose and mouth. Air that is exiting from the second outflow openings 96 forms a supply air stream 83 which flows into the interior of the hood 86 and provides breathing air for the user. The design of the supply air stream 83 and the shielding air stream 84 can be adapted to the application situation and corresponds advantageously to the design of the preceding embodiments.

FIG. 16 shows an embodiment of a supply device 101 which is provided on a hooded sweater 85, in particular on its hood 86. On rim 87 of the hood 86 first outflow openings 95 are provided which corresponds to the outflow openings 95 described in FIGS. 14 and 15 and which generate a shielding air stream. The supply device 101 comprises also second outflow openings 106 which flow into the breathing air region 82 formed in the interior of the hood 86. The second outflow openings 106 are distributed across a major part of the interior surface of the hood 86. It can also be provided that second outflow openings 106 are provided only in individual areas of the inner surface of the hood 86. The air which is exiting from the first outflow openings 95 shields the breathing air region 82 relative to the surroundings. The design of the outflow openings and thus the design of the air streams corresponds here also to the design of the preceding embodiments.

Another arrangement or fixation of a supply device 1, 51, 81 or 101 or a use in another application area can be expedient also. The supply devices 81 or 101 can also be provided on a separate hood or on another headgear.

It can be advantageous to provide a regulating and/or switch-off device for the supply air stream and/or the shielding air stream. In particular, it can be advantageous to design the shielding air stream so that it can be reduced or switched off. In this way, energy can be saved. In particular when the supply device is not moving, the supply air stream can be sufficient to ensure that the operator does not, or hardly, breathes in ambient air. A regulating device for the shielding air stream can also be provided so that the operator can adjust the air flow rate such that no draft is produced. For regulating or switching off the supply air stream, a throttle can be arranged, for example, in a channel which is extending to an outflow opening for the supply air stream.

It can also be provided to automatically adjust the supply air stream. For this purpose, one or several sensors can be provided which, for example, measure the wind conditions, the movement speed of the supply device, or the like and as a function of the measured result or measured results effect an adaptation or switching off of the supply air stream. The detection of the wind conditions, of the movement speed, or the like can advantageously be done electrically. Advantageously, the adaptation or switching off of the supply air stream can be done electrically.

What is claimed is:

1-12. (canceled)

13. A supply device for supply of breathing air into a breathing air region that is at least partially open toward the surroundings, the supply device comprising:
means for generating a supply air stream of breathing air to be supplied into the breathing air region;
means for generating at least one shielding air stream shielding the breathing air region at least partially relative to the surroundings.

14. The supply device according to claim 13, wherein a flow rate of the at least one shielding air stream is greater than a flow rate of the supply air stream.

15. The supply device according to claim 14, wherein the flow rate of the at least one shielding air stream is approximately 0.3 m/s to approximately 1.5 m/s and wherein the flow rate of the supply air stream is not more than approximately 0.25 m/s.

16. The supply device according to claim 13, wherein the means for generating the at least one shielding air stream comprise at least one first outflow opening and wherein the means for generating the supply air stream comprise at least one second outflow opening.

17. The supply device according to claim 16, wherein a width of the at least one first outflow opening is smaller than a width of the at least one second outflow opening.

18. The supply device according to claim 16, further comprising a blower that sucks in and conveys ambient air to the at least one first outflow opening and/or the at least one second outflow opening.

19. The supply device according to claim 18, further comprising at least one filter, wherein the ambient air is sucked in through the at least one filter.

20. The supply device according to claim 16, further comprising a supply part on which the at least one first outflow opening and the at least one second outflow opening are arranged, wherein the supply part comprises at least one connector configured to connect to an air supply.

21. The supply device according to claim 20, wherein the supply part comprises at least one first sub-channel and at least one second sub-channel, wherein the at least one first sub-channel communicates with the at least one first outflow opening and supplies air to the at least one first outflow opening, and wherein the at least one second sub-channel communicates with the at least one second outflow opening and supplies air to the at least one second outflow opening.

22. The supply device according to claim 20, wherein a position of the at least one first outflow opening and/or of the at least one second outflow opening on the supply part is adjustable.

23. The supply device according to claim 20, wherein the supply part comprises a support section configured to support the supply part on a user and wherein the at least one first outflow opening and the at least one second outflow opening are open toward a side of the supply part which is facing away from the support section.

24. The supply device according to claim 13, further comprising at least one fastening element.
